(19) United States
(12) Patent Application Publication
(10) Pub. No.: US 2009/0212993 A1
(43) Pub. Date: Aug. 27, 2009

(54) COLLISION DETECTION APPARATUS, VEHICLE HAVING SAME APPARATUS, AND COLLISION DETECTION METHOD

(75) Inventors: Jun TSUNEKAWA, Nagoya-shi (JP); Tomoya Kawasaki, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/360,524

(22) Filed: Jan. 27, 2009

(30) Foreign Application Priority Data
Feb. 22, 2008 (JP) 2008-042058

(51) Int. Cl. G01S 13/93

(52) U.S. Cl. 342/71; 342/70

(57) ABSTRACT

A collision detection apparatus incorporated in a vehicle has: a radar that detects an object; and a controller that determines whether there is a possibility of collision between the vehicle and the object based on a result of detection by the radar. A detection-direction center axis of the radar is tilted to right or left by 20° to 60° with respect to a straightforward running direction of the vehicle.

### INCORPORATION BY REFERENCE

The disclosure of Japanese Patent Application No. 2008-42058 filed on Feb. 22, 2008 including the specification, drawings and abstract is incorporated herein by reference in its entirety.

### BACKGROUND OF THE INVENTION

1. Field of the Invention

The invention relates to a collision detection apparatus, and particularly to a collision detection apparatus that detects an object approaching a vehicle incorporating said apparatus sideways. Further, the invention relates to a vehicle incorporating such a collision detection apparatus and to a collision detection method.

2. Description of the Related Art

In the art, technologies are known in which a subject vehicle incorporates a radar, or the like, and detects other vehicle approaching the subject vehicle sideways, and if it is determined that there is a possibility of collision between the subject vehicle and the approaching vehicle, a warning device, a collision damage reduction device, and so on, are activated. For example, one of such technologies is described in Japanese Patent Application Publication No. 2005-82124 (JP-A-2005-82124). According to JP-A-2005-82124, a radar is arranged in a subject vehicle so as to detect other vehicles approaching the subject vehicle sideways, and the detection area of the radar is changed in accordance with the running speed of the subject vehicle. According to this technology, other vehicles approaching the subject vehicle sideways can be efficiently detected.

In reality, there exist various road environments such as crossroads, Y-shaped intersections, and so on, and therefore the position of an object (e.g., other vehicle) at which it is visually captured by the subject vehicle after getting out of a blind spot of the subject vehicle varies depending on road environments. According to JP-2005-82124, however, the detection area of the radar is set based on the running state of the subject vehicle only, that is, the actual road environments are not taken into consideration when setting the detection area of the radar. According to JP-2005-82124, therefore, other vehicles approaching the subject vehicle sideways can not be efficiently detected.

### SUMMARY OF THE INVENTION

The invention provides a collision detection apparatus that is capable of efficiently detecting an object approaching a subject vehicle sideways, a vehicle incorporating such a collision detection apparatus, and a collision detection method.

The first aspect of the invention relates to a collision detection apparatus incorporated in a vehicle. This collision detection apparatus has a radar and a controller. The radar detects an object, and the controller determines whether there is a possibility of collision between the vehicle and the object based on a result of detection by the radar. A detection-direction center axis of the radar is tilted to right or left by 20° to 60° with respect to a straightforward running direction of the vehicle.

According to the collision detection apparatus described above, an object approaching the subject vehicle sideways can be efficiently detected.

The collision detection apparatus of the first aspect of the invention may be such that the controller performs at least one of a collision avoidance operation and a collision damage reduction operation based on a result of the determination as to the collision possibility.

Further, the collision detection apparatus of the first aspect of the invention may be such that: the radar has a detection area that horizontally extends from the detection-direction center axis to each side by 18° to 23°; and the detection-direction center axis of the radar is tilted to right or left by 20° to 40° with respect to the straightforward running direction of the vehicle. According to this structure, in a case where the radar has a detection area horizontally extending from the detection-direction center axis to each side by 18° to 23°, an object approaching the subject vehicle sideways can be efficiently detected.

Further, the collision detection apparatus of the first aspect of the invention may be such that: the radar has a detection area that horizontally extends from the detection-direction center axis to each side by 20°; and the detection-direction center axis of the radar is tilted to right or left by 25° to 30° with respect to the straightforward running direction of the vehicle. According to this structure, in a case where the radar has a detection area horizontally extending from the detection-direction center axis to each side by 20°, an object approaching the subject vehicle sideways can be efficiently detected.

Further, the collision detection apparatus of the first aspect of the invention may be such that: the radar has a detection area that horizontally extends from the detection-direction center axis to each side by 38° to 43°; and the detection-direction center axis of the radar is tilted to right or left by 40° to 60° with respect to the straightforward running direction of the vehicle. According to this structure, in a case where the radar has a detection area horizontally extending from the detection-direction center axis to each side by 38° to 43°, an object approaching the subject vehicle sideways can be efficiently detected.

Further, the collision detection apparatus of the first aspect of the invention may be such that: the radar has a detection area that horizontally extends from the detection-direction center axis to each side by 38° to 43°; and the detection-direction center axis of the radar is tilted to right or left by 45° to 60° with respect to the straightforward running direction of the vehicle. According to this structure, in a case where the radar has a detection area horizontally extending from the detection-direction center axis to each side by 38° to 43°, an object approaching the subject vehicle sideways can be more efficiently detected.

Further, the collision detection apparatus of the first aspect of the invention may be such that: a maximum detection distance of the radar is 30 m; and it takes at least 0.65 second for the controller to perform the collision avoidance operation after receiving a result of detection by the radar. According to this structure, the danger avoidance operation can be reliably performed.

Further, the collision detection apparatus of the first aspect of the invention may be such that: a maximum detection distance of the radar is 30 m; and it takes at least 0.65 second for the controller to perform the collision damage reduction operation after receiving a result of detection by the radar. According to this structure, the collision damage reduction operation can be reliably performed.

Further, the collision detection apparatus of the first aspect of the invention may be such that the detection-direction center axis of the radar is a horizontal center axis extending in a direction in which the radar detects the object by emitting electromagnetic waves. Further, the collision detection apparatus of the first aspect of the invention may be such that electromagnetic waves emitted by the radar are millimeter waves.

The second aspect of the invention relates to a vehicle. This vehicle incorporates a collision detection apparatus and a safety system. The collision detection apparatus has a radar that detects an object and a controller that determines whether there is a possibility of collision between the vehicle and the object based on a result of detection by the radar, and the detection-direction center axis of the radar is tilted to right or left by 20° to 60° with respect to a straightforward running direction of the vehicle. The safety system performs at least one of a collision avoidance operation and a collision damage reduction operation under the control of the controller.

The vehicle of the second aspect of the invention may be such that: the collision avoidance operation is an operation for assisting braking operation that a driver of the vehicle performs to avoid collision between the vehicle and the object; and the safety system incorporates a danger avoidance device that assists the braking operation.

Further, the vehicle of the second aspect of the invention may be such that: the collision damage reduction operation is an operation for further restricting an occupant of the vehicle; and the safety system incorporates a collision damage reduction apparatus that further restricts the occupant.

The third aspect of the invention relates to a collision detection method for a vehicle incorporating a radar that detects an object. This method includes: arranging the radar such that a horizontal center axis extending in a direction in which the radar detects the object by emitting electromagnetic waves is tilted to right or left by 20° to 60° with respect to a straightforward running direction of the vehicle; and determining whether there is a possibility of collision between the vehicle and the object based on a result of detection by the radar.

The collision detection method of the third aspect of the invention may further include performing at least one of a collision avoidance operation and a collision damage reduction operation based on a result of the determination as to the collision possibility.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram illustrating the configuration of a collision detection apparatus of the first example embodiment of the invention;

FIG. 2 is a view illustrating the arrangement of a right radar 11 and a left radar 12 of the collision detection apparatus of the first example embodiment;

FIG. 3 is a view illustrating a typical example of head-to-head collision and indicating the distance from a subject vehicle 1 to the collision point and the distance from an object vehicle 2 to the collision point;

FIG. 4 is a chart on which the positions of other vehicles at which they were visually captured by the subject vehicle 1 are plotted;

FIG. 5 is a chart on which the positions of other vehicles at which they were visually captured by the subject vehicle 1 are plotted and the detection areas of the right and left radars 11, 12 are overlaid;

FIG. 6 is a graph illustrating the relation between the mount angle θ of the radars 11, 12 and the detection rate P when radars each having a detection area with the view angle α of 20° and the maximum diction distance L of 30 m are used as the radars 11, 12 in the first example embodiment of the invention;

FIG. 7 is a graph illustrating the relation between the mount angle θ of the radars 11, 12 and the detection rate P when radars each having a detection area with the view angle α of 18° and the maximum diction distance L of 30 m are used as the radars 11, 12 in the first example embodiment of the invention;

FIG. 8 is a graph illustrating the relation between the mount angle θ of the radars 11, 12 and the detection rate P when radars each having a detection area with the view angle α of 23° and the maximum diction distance L of 30 m are used as the radars 11, 12 in the first example embodiment of the invention;

FIG. 9 is a graph illustrating the relation between the mount angle θ of the radars 11, 12 and the detection rate P when radars each having a detection area with the view angle α of 40° and the maximum diction distance L of 30 m are used as the radars 11, 12 in the second example embodiment of the invention;

FIG. 10 is a graph illustrating the relation between the mount angle θ of the radars 11, 12 and the detection rate P when radars each having a detection area with the view angle α of 38° and the maximum diction distance L of 30 m are used as the radars 11, 12 in the second example embodiment of the invention; and

FIG. 11 is a graph illustrating the relation between the mount angle θ of the radars 11, 12 and the detection rate P when radars each having a detection area with the view angle α of 43° and the maximum diction distance L of 30 m are used as the radars 11, 12 in the second example embodiment of the invention.

### DETAILED DESCRIPTION OF THE EMBODIMENTS

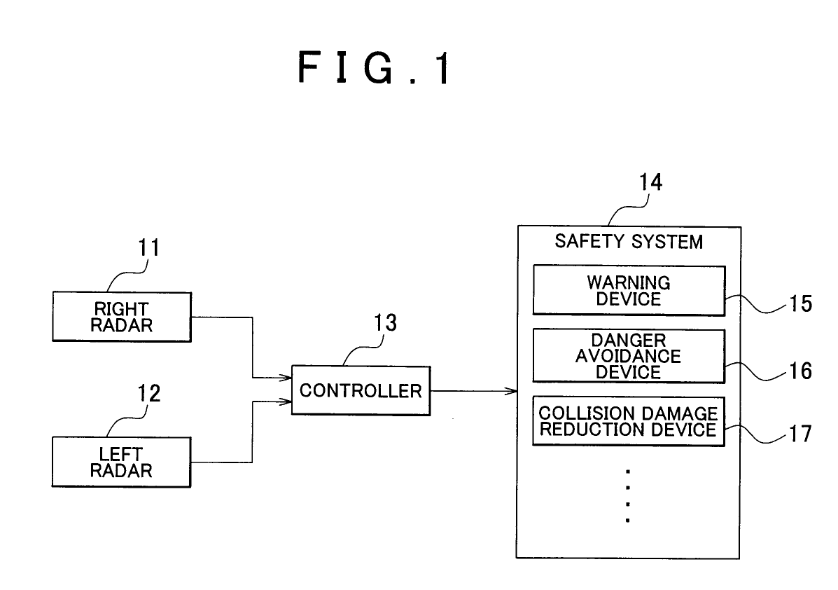

Hereinafter, a collision detection apparatus according to the first example embodiment of the invention will be described with reference to the accompanying drawings. FIG. 1 is a block diagram illustrating an example configuration of the collision detection apparatus of the first example embodiment of the invention. Referring to FIG. 1, the collision detection apparatus has a right radar 11 for detecting objects on the front-right side of the motor vehicle, a left radar 12 for detecting objects on the front-left side of the motor vehicle, a controller 13, and a safety system 14.

The right and left radars 11, 12 each detect an object approaching the motor vehicle incorporating the collision detection apparatus (will hereinafter be referred to as “subject motor vehicle 1”) sideways. The right and left radars 11, 12 are disposed at predetermined positions at the front side of the subject motor vehicle 1. Preferably, millimeter-wave radars are used as the right and left radars 11, 12. This is because they are less subject to natural environmental conditions, such as rainfalls, fogs, and so on, and they therefore provide a higher object detection performance. While motor vehicles, bicycles, pedestrians, and so on, can be detected by the right and left radars 11, 12, the following description refers to example cases where the right and left radars 11, 12 detect a motor vehicle (will hereinafter be referred to “object motor vehicle 2”) as a detection object.

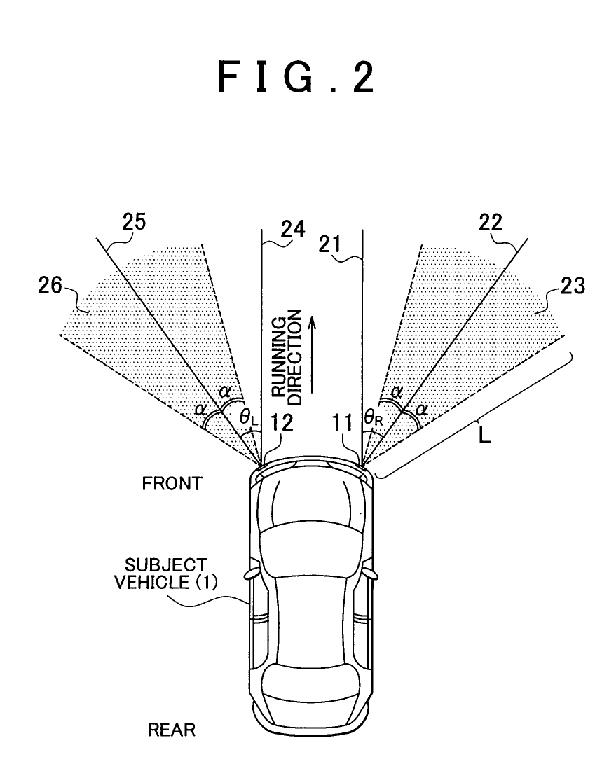

FIG. 2 illustrates example arrangements of the right and left radars 11, 12. Referring to FIG. 2, the right radar 11 is arranged at the right side of the front portion of the subject motor vehicle 1, and the left radar 12 is arranged at the left side of the front portion of the subject motor vehicle 1. Hereinafter, a detection area 23 of the right radar 11 will be described. Note that the following description on the detection area 23 of the right radar 11 also applies to a detection area 26 of the left radar 12 and therefore explanations on the detection area 26 will be simplified and omitted.

Referring to FIG. 2, “L” represents the maximum detection distance of the right radar 11 in the horizontal direction (will hereinafter be referred to as “maximum detection distance L”). The detection area 23 of the right radar 11 horizontally extends from a detection-direction center axis 22 to each side by an angle α (will be referred to as “view angle α). That is, the maximum detection distance L and the view angle α define the detection area 23 of the right radar 11. Thus, when detecting the object motor vehicle 2, the right radar 11 can detect it if it is located in the detection area 23. Referring to FIG. 2, a mount angle θR is an angle between a straight line 21 running in parallel to the traveling direction of the subject motor vehicle 1 and the detection-direction center axis 22. Note that the detection area 26 of the left radar 12 is also defined by the maximum detection distance L and the view angle α and a mount angle θL is an angle between a straight line 24 running in parallel to the traveling direction of the subject motor vehicle 1 and a detection-direction center axis 25 of the left radar 12. The detection-direction center axis 22 is a horizontal center axis running in the direction in which the right radar 11 detects the object motor vehicle 2 by emitting electromagnetic waves, and the detection-direction center axis 25 is a horizontal center axis running in the direction in which the left radar 12 detects the object motor vehicle 2 by emitting electromagnetic waves.

Referring back to FIG. 1, the controller 13 is constituted of a CPU (Central Processing Unit), a memory, and so on. The controller 13 governs the overall control of respective devices and components provided in the subject motor vehicle 1 incorporating the collision detection apparatus of the first example embodiment. More specifically, based on the information output from the right and left radars 11, 12, the controller 13 determines whether there is a possibility of collision between the subject motor vehicle 1 and the object motor vehicle 2 approaching the subject motor vehicle 1 sideways and determines whether it is possible to avoid collision between the subject motor vehicle 1 and the object motor vehicle 2. Then, based on the results of such determinations, the controller 13 activates the safety system 14. Note that the information output from the right and left radars 11, 12 includes, for example, the running speed of the object motor vehicle 2 and the distance between the subject motor vehicle 1 and the object motor vehicle 2.

The safety system 14 is provided in the subject motor vehicle 1 incorporating the collision detection apparatus of the first example embodiment. For example, in a case where there is a possibility of collision between the subject motor vehicle 1 and the object motor vehicle 2, the safety system 14 performs safety operation for calling for attention of the driver in accordance with corresponding commands from the controller 13. Further, in a case where collision between the subject motor vehicle 1 and the object motor vehicle 2 is unavoidable, the controller 13 performs safety operation for reducing damages on the occupants of the subject motor vehicle 1 in accordance with corresponding commands from the controller 13. In the following, such operations performed by the safety system 14 will be collectively referred to as “safety operations” where necessary.

Hereinafter, example components of the safety system 14 will be described. First, in a case where the controller 13 has determined, based on the information output from the right and left radars 11, 12, that there is a possibility of collision between the subject motor vehicle 1 and the object motor vehicle 2, a warning device 15 activates a warning lamp, a warning buzzer, or the like, to call for attention of the driver of the subject motor vehicle 1. Further, the safety system 14 has a danger avoidance device 16 that assists the brake operation that the driver of the subject motor vehicle 1 performs to avoid collision with the object motor vehicle 2. Further, the safety system 14 has a collision damage reduction device 17 that, when the controller 13 has determined that collision between the subject motor vehicle 1 and the object motor vehicle 2 is unavoidable, reduces the damages on the occupants of the subject motor vehicle 1 by further restricting them by, for example, automatically winding up their seatbelts and driving their seats. More specifically, such damage reduction operations of the collision damage reduction device 17 include canceling the safety lock of the airbags and changing the positions of the respective seats to given safety positions. It is to be noted that the above-described components of the safety system 14 are only exemplary and the safety system 14 may include various other components if appropriate.

As described above, the collision detection apparatus of the first example embodiment is capable of detecting the object motor vehicle 2 when it is located in the detection area 23 of the right radar 11 or in the detection area 26 of the right radar 11. Then, if the controller 13 has determined that there is a possibility of collision between the subject motor vehicle 1 the detected object motor vehicle 2 or that said collision is unavoidable, the safety system 14 performs the safety operations.

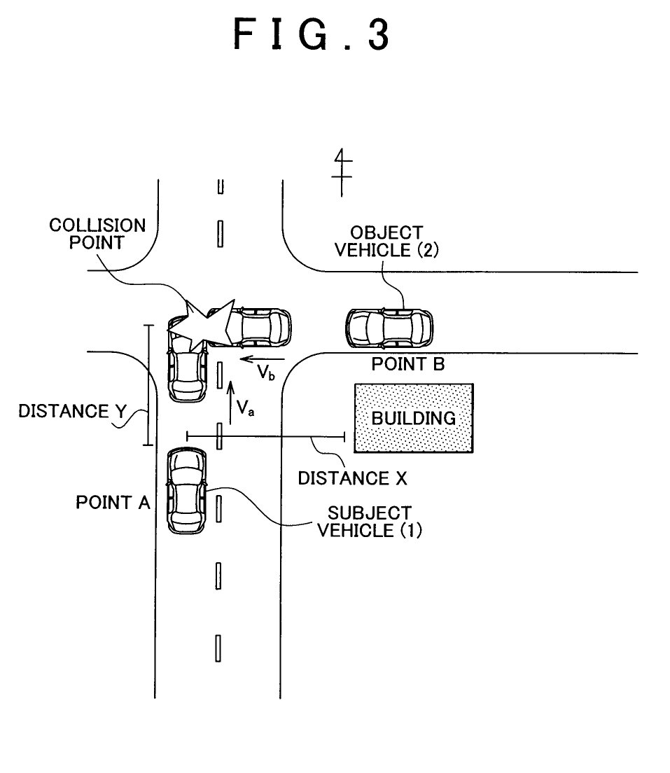

FIG. 3 illustrates a typical example of head-to-head collision. In this example, the subject motor vehicle 1 collides with the object motor vehicle 2 approaching the subject motor vehicle 1 from one side. Referring to FIG. 3, the subject motor vehicle 1 running from south to north collides head-to-head with the object motor vehicle 2 running from east to west at an intersection. That is, the object motor vehicle 2 approaches the subject motor vehicle 1 from the right side and collides head-to-head with the subject motor vehicle 1. In FIG. 3, “Va” represents the running speed of the subject motor vehicle 1 upon the collision and “Vb” represents the running speed of the object motor vehicle 2 upon the collision. In this example, it is assumed that the subject motor vehicle 1 and the object motor vehicle 2 are each running at a constant speed. That is, it is assumed that the subject motor vehicle 1 is running at the speed Va toward the collision point from south and the object motor vehicle 2 is running at the speed Vb toward the collision point from east.

The collision detection apparatus of the first example embodiment monitors the areas diagonally ahead of the subject motor vehicle 1 using the right and left radars 11, 12, respectively, and detects the object motor vehicle 2 when it is starting to get out of a blind spot that is created by, for example, buildings, walls, and trees present on roadside. Then, if it is determined that there is a possibility of collision between the object motor vehicle 2 and the subject motor vehicle 1 or that said collision is unavoidable, the collision detection apparatus performs the safety operations. While the object motor vehicle 2 can be detected in the above-described manner also when it is coming from the left side of the subject motor vehicle 1, the description will be hereinafter continued with reference to a case where the subject motor vehicle 1 collides head-to-head with the object motor vehicle 2 coming from the right side of the subject motor vehicle 1.

Next, the positions of the subject motor vehicle 1 and the object motor vehicle 2 at which they visually capture each other will be described with reference to the typical head-to-head collision example illustrated in FIG. 3. In FIG. 3, “DISTANCE X” represents the relative distance in X direction between the positions of the subject motor vehicle 1 and the object motor vehicle 2 at which they visually capture each other (“POINT A” and “POINT B”), and “DISTANCE Y” represents the relative distance in Y direction between said positions of the subject motor vehicle 1 and the object motor vehicle 2.

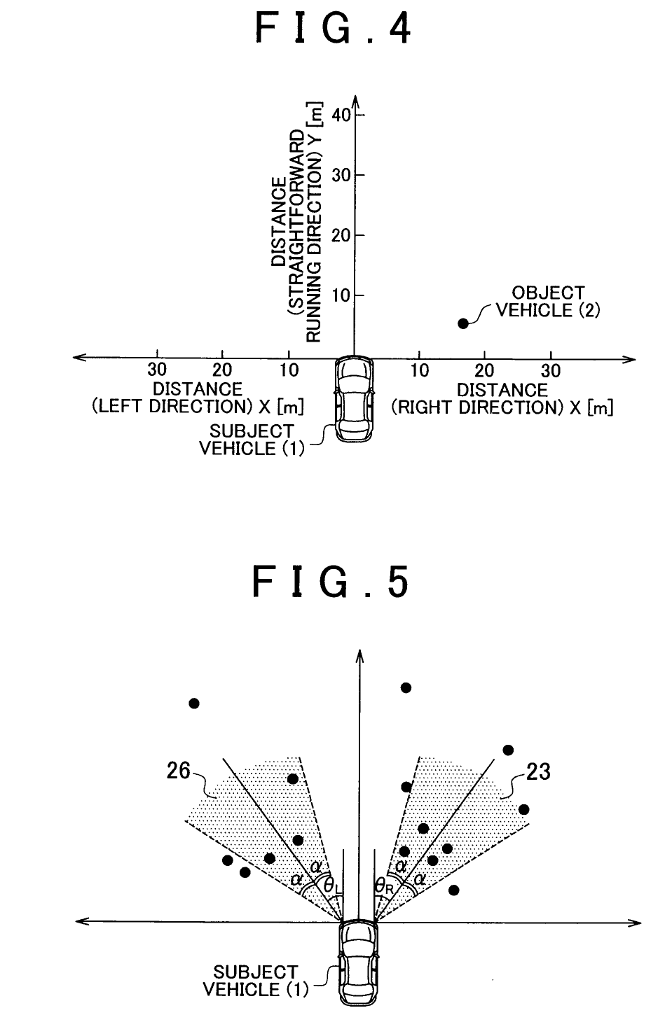

Plotted on the chart of FIG. 4 is the position of the object motor vehicle 2 (“POINT B” in FIG. 3) relative to the position of the subject motor vehicle 1 (“POINT A” in FIG. 3) at which the subject motor vehicle 1 captures the object vehicle 1. In the example illustrated in FIG. 4, the distance X is 16 m and the distance Y is 6 m. That is, the vertical axis of the chart of FIG. 4 represents the distance Y and the horizontal axis represents the distance X. The chart clearly indicates the positions of the subject motor vehicle 1 and the object motor vehicle 2 at which they visually capture each other before collision. In the following, such positions will be referred to as “visually-captured position”.

Plotted on the chart of FIG. 5 are the visually-captured positions of object motor vehicles in some actual head-to-head collisions. The hatched regions overlaid on the chart of the FIG. 5 represent the detection areas 23, 26 of the right and left radars 11, 12 having given specifications (i.e., the maximum detection distance L and the view angle α), respectively. Referring to FIG. 5, the visually-captured positions in the detection area 23 of the right radar 11 and the detection area 26 in the left radar 12 are detectable by the right and left radars 11, 12, respectively. That is, in a case where the detection area 23 of the right radar 11 and the detection area 26 of the right radar 11 are set as shown in the chart of FIG. 5, the collision detection apparatus can detect the object motor vehicle 2 using the right radar 11 or the left radar 12 if the visually-captured position of the object motor vehicle 2 is in the detection area 23 or 26. That is, if the right and left radars 11, 12 were incorporated in each of the vehicles that went through the actual collisions illustrated in the FIG. 5, the collisions corresponding to the visually-captured positions plotted within the detection area 23 of the right radar 11 and the detection area 26 of the left radar 12 could have been avoided. As such, it is desirable to mount the right and left radars 11, 12 such that the detection area 23 of the right radar 11 and the detection area 26 of the left radar 12 cover as many of the points in the chart of FIG. 5 as possible, and therefore the mount angles of the right and left radars 11, 12 need to be properly set so as to achieve such detection areas of the right and left radars 11, 12.

In view of the above, in this example embodiment of the invention, a detection rate P representing the number of points in the detection area 23 of the right radar 11 and the detection area 26 of the left radar 12 is calculated. More specifically, the detection rate P represents the ratio of the number of the points plotted in the detection area 23 of the right radar 11 and the detection area 26 of the left radar 12 to the total number of the plotted points. Thus, based on this detection rate P, it is possible to determine the values of the mount angles θR, θL at which the right and left radars 11, 12 can efficiently detect the object motor vehicle 2.

In reality, not only crossroads, there are roads having various other shapes such as T-shaped intersections, Y-shaped intersections, and so on, and further, buildings, walls, trees, and so on, on road sides have various shapes. Thus, the positions of the subject motor vehicle 1 and the object motor vehicle 2 at which they visually capture each other vary depending upon such factors. In view of this, the present inventors conducted a detailed research on actual examples of head-to-head collisions. In the research, the present inventors investigated the position of the object motor vehicle 2 at which the object motor vehicle 2 was visually captured by the subject motor vehicle 1 in each collision, and the present inventors also investigated the running speeds of the subject motor vehicle 1 and the object motor vehicle 2 at the time of each collision. Then, the present inventors plotted the visually-captured position of the object motor vehicle 2 in each collision on the chart shown in FIG. 4, and then they overlaid the detection area 23 of the right radar 11 and the detection area 26 of the left radar 12 on the chart as shown in FIG. 5 and then calculated the detection rate P. Then, the present inventors studied the relation between the mount angle θ and the detection rate P by calculating the detection rate P while changing the mount angle θ (|θR|=|θL|) of each radar 11, 12.

With regard to the calculation of the detection rate P, among the visually-captured positions plotted on the chart, the detection rate P was calculated only with the visually-captured positions corresponding to the collisions in which the time from when the object motor vehicle 2 was visually captured by the subject motor vehicle 1 to when the object motor vehicle 2 collided with the subject motor vehicle 1 was 0.65 sec or longer. This is because the collision detection apparatus of the first example embodiment takes at least 0.65 sec to determine whether there is a possibility of collision between the subject motor vehicle 1 and the object motor vehicle 2 and then activate the safety system 14.

Then, based on such information obtained from the actual examples of head-to-head collisions, the present inventors studied the relation between the mount angle θ of the right and left radars 11, 12 having given specifications and the detection rate P as described in detail below.

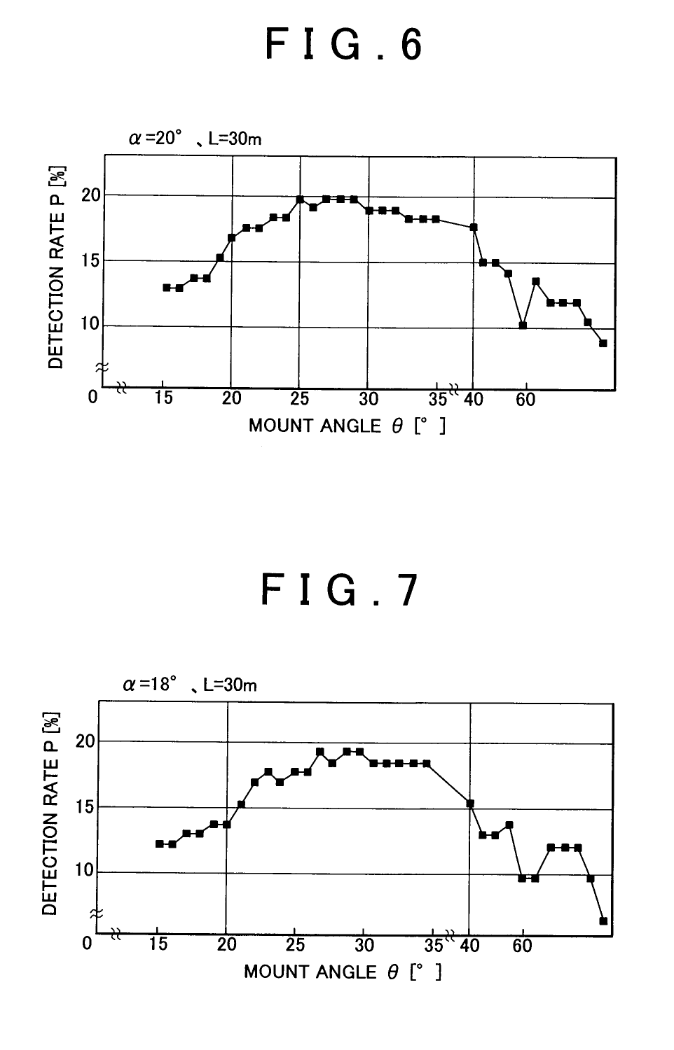

The graph of FIG. 6 illustrates the relation between the detection rate P and the mount angle θ of the right and left radars 11, 12 in a case where radars each having a detection area with the view angle α of 20° and the maximum detection distance L of 30 m were used as the right and left radars 11, 12. In this case, as shown in FIG. 6, the detection rate P was high when the right and left radars 11, 12 were each mounted at the mount angle θ of 20° to 40°, and especially at the mount angle θ of 25° to 30°. As such, in a case where the right and left radars 11, 12 each have a detection area with the view angle α of 20° and the maximum detection distance L of 30 m, if the right and left radars 11, 12 are each mounted on the subject motor vehicle 1 at the mount angle θ of 20° to 40°, more preferably 25° to 30°, the collision detection apparatus can efficiently detect the object motor vehicle 2.

Next, radars each having a detection area with the view angle α of 18° and the maximum detection distance L of 30 m were used as the right and left radars 11, 12, and the detection rate P was obtained in the same manner as described above. The graph of FIG. 7 illustrates the relation between the detection rate P and the mount angle θ of the right and left radars 11, 12 having a detection area with the view angle α of 18° and the maximum detection distance L of 30 m. In this case, as shown in FIG. 7, the detection rate P was high when the right and left radars 11, 12 were each mounted at the mount angle θ of 20° to 40°. As such, in a case where the right and left radars 11, 12 each have a detection area with the view angle α of 18° and the maximum detection distance L of 30 m, if the right and left radars 11, 12 are each mounted on the subject motor vehicle 1 at the mount angle θ of 20° to 40°, the collision detection apparatus can efficiently detect the object motor vehicle 2.

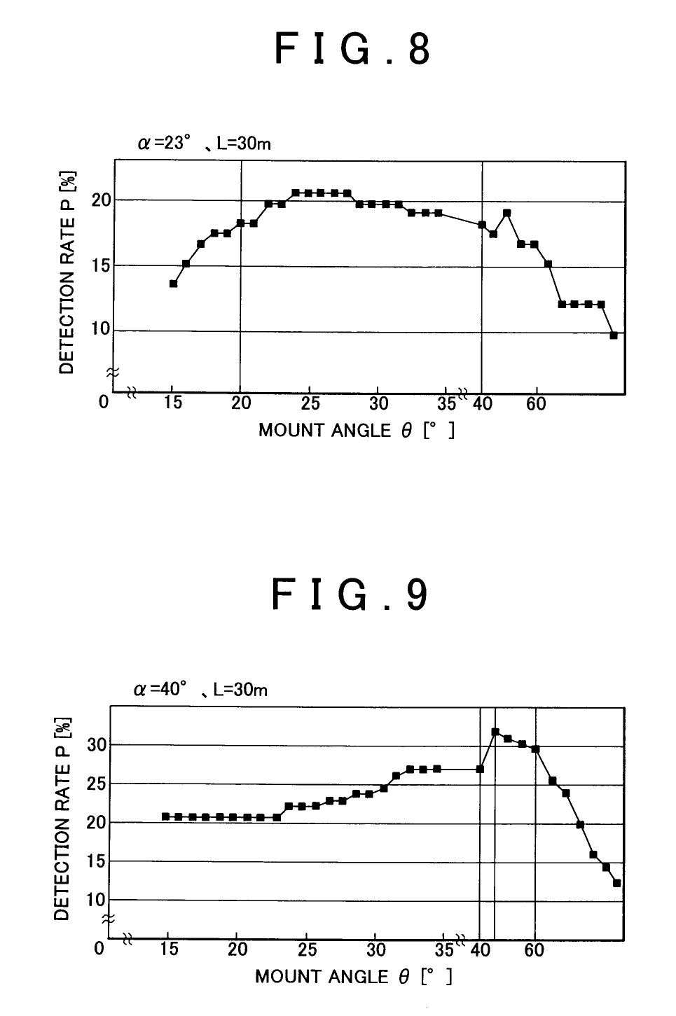

Next, radars each having a detection area with the view angle α of 23° and the maximum detection distance L of 30 m were used as the right and left radars 11, 12, and the detection rate P was obtained in the same manner as described above. The graph of FIG. 8 illustrates the relation between the detection rate P and the mount angle θ of the right and left radars 11, 12 having a detection area with the view angle α of 23° and the maximum detection distance L of 30 m. In this case, as shown in FIG. 8, the detection rate P was high when the right and left radars 11, 12 were each mounted at the mount angle θ of 20° to 40°. As such, in a case where the right and left radars 11, 12 each have a detection area with the view angle α of 23° and the maximum detection distance L of 30 m, if the right and left radars 11, 12 are each mounted on the subject motor vehicle 1 at the mount angle θ of 20° to 40°, the collision detection apparatus can efficiently detect the object motor vehicle 2.

The results illustrated in FIG. 6 to FIG. 8 can be concluded as follows. In a case where radars each having a detection area with the view angle α of 18° to 23° and the maximum detection distance L of 30 m are mounted on the subject motor vehicle 1, if they are mounted at the mount angle θ of 20° to 40°, the collision detection apparatus can efficiently detect the object motor vehicle 2. In this case, in particular, if the view angle α of the detection area of each radar is 20°, it is desirable to mount the radars on the subject motor vehicle 1 at the mount angle θ of 25° to 30°.

Next, a collision detection apparatus according to the second example embodiment of the invention will be described. According to the collision detection apparatus of the first example embodiment, as described above, the detection rate P was calculated for the radars each having a detection area with the view angle α of 18° to 23° and the maximum detection distance L of 30 m and the optimum value of the mount angle θ of each radar was determined based on the calculated detection rate P. In the second example embodiment, on the other hand, the horizontal detection area of each radar, that is, the view angle α of each radar is wider than those used in the first example embodiment. It is to be noted that the configuration of the collision detection apparatus of the second example embodiment is the same as that of the collision detection apparatus of the first example embodiment and therefore it is not described here again. Further, it is to be noted that the detection rate P was calculated in the same method as in the first example embodiment and therefore it is not described here again.

The graph of FIG. 9 illustrates the relation between the detection rate P and the mount angle θ of the right and left radars 11, 12 in a case where radars each having a detection area with the view angle α of 40° and the maximum detection distance L of 30 m were used as the right and left radars 11, 12. In this case, as shown in FIG. 6, the detection rate P was high when the right and left radars 11, 12 were each mounted at the mount angle θ of 40° to 60°, and especially 45° to 60°. As such, in a case where the right and left radars 11, 12 each have a detection area with the view angle α of 40° and the maximum detection distance L of 30 m, if the right and left radars 11, 12 are each mounted on the subject motor vehicle 1 at the mount angle θ of 40° to 60°, more preferably 45° to 60°, the collision detection apparatus can efficiently detect the object motor vehicle 2.

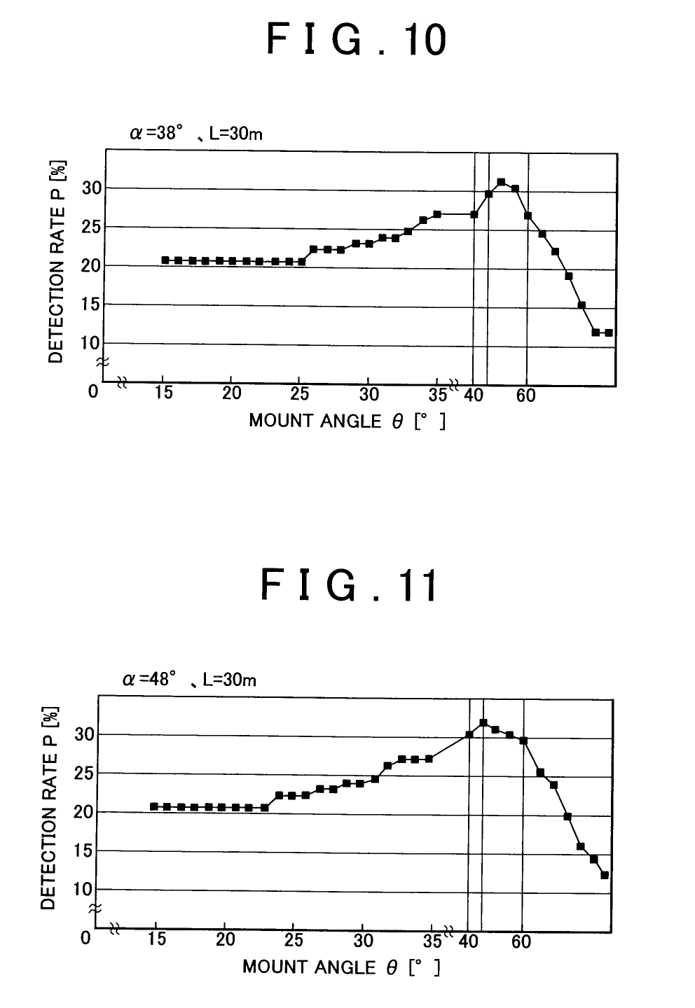

Next, radars each having a detection area with the view angle α of 38° and the maximum detection distance L of 30 m were used as the right and left radars 11, 12, and the detection rate P was obtained in the same manner as described above. The graph of FIG. 10 illustrates the relation between the detection rate P and the mount angle θ of the right and left radars 11, 12 having a detection area with the view angle α of 38° and the maximum detection distance L of 30 m. In this case, as shown in FIG. 10, the detection rate P was high when the right and left radars 11, 12 were each mounted at the mount angle θ of 40° to 60°, especially 45° to 60°. As such, in a case where the right and left radars 11, 12 each have a detection area with the view angle α of 38° and the maximum detection distance L of 30 m, if the right and left radars 11, 12 are each mounted on the subject motor vehicle 1 at the mount angle θ of 40° to 60°, more preferably 45° to 60°, the collision detection apparatus can efficiently detect the object motor vehicle 2.

Next, radars each having a detection area with the view angle α of 43° and the maximum detection distance L of 30 m were used as the right and left radars 11, 12, and the detection rate P was obtained in the same manner as described above. The graph of FIG. 11 illustrates the relation between the detection rate P and the mount angle θ of the right and left radars 11, 12 having a detection area with the view angle α of 43° and the maximum detection distance L of 30 m. In this case, as shown in FIG. 11, the detection rate P was high when the right and left radars 11, 12 were each mounted at the mount angle θ of 40° to 60°, and especially at the mount angle θ of 45° to 60°. As such, in a case where the right and left radars 11, 12 each have a detection area with the view angle α of 43° and the maximum detection distance L of 30 m, if the right and left radars 11, 12 are each mounted on the subject motor vehicle 1 at the mount angle θ of 40° to 60°, more preferably 45° to 60°, the collision detection apparatus can efficiently detect the object motor vehicle 2.

The results illustrated in FIG. 9 to FIG. 11 can be concluded as follows. In a case where radars each having a detection area with the view angle α of 38° to 43° and the maximum detection distance L of 30 m are mounted on the subject motor vehicle 1, if they are mounted at the mount angle θ of 40° to 60°, the collision detection apparatus can efficiently detect the object motor vehicle 2. In this case, in particular, it is desirable to mount each radar on the subject vehicle 1 at the mount angle θ of 45° to 60°.

While the invention has been described with reference to the example embodiments, it should be understood that the invention is not limited to the example embodiments. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

Thus, collision detection apparatuses of the invention can be effectively used as, for example, a collision detection apparatus that is mounted in a vehicle to detect an object approaching the vehicle sideways.

What is claimed is:

1. A collision detection apparatus incorporated in a vehicle, comprising:
a radar that detects an object; and
a controller that determines whether there is a possibility of collision between the vehicle and the object based on a result of detection by the radar, wherein
a detection-direction center axis of the radar is tilted to right or left by 20° to 60° with respect to a straightforward running direction of the vehicle.

2. The collision detection apparatus according to claim 1, wherein:
the controller performs at least one of a collision avoidance operation and a collision damage reduction operation based on a result of the determination as to the collision possibility.

3. The collision detection apparatus according to claim 1, wherein:
the radar has a detection area that horizontally extends from the detection-direction center axis to each side by 18° to 23°; and
the detection-direction center axis of the radar is tilted to right or left by 20° to 40° with respect to the straightforward running direction of the vehicle.

4. The collision detection apparatus according to claim 3, wherein:
the radar has a detection area that horizontally extends from the detection-direction center axis to each side by 20°; and
the detection-direction center axis of the radar is tilted to right or left by 25° to 30° with respect to the straightforward running direction of the vehicle.

5. The collision detection apparatus according to claim 1, wherein:
the radar has a detection area that horizontally extends from the detection-direction center axis to each side by 38° to 43°; and
the detection-direction center axis of the radar is tilted to right or left by 40° to 60° with respect to the straightforward running direction of the vehicle.

6. The collision detection apparatus according to claim 5, wherein:
the radar has a detection area that horizontally extends from the detection-direction center axis to each side by 38° to 43°; and
the detection-direction center axis of the radar is tilted to right or left by 45° to 60° with respect to the straightforward running direction of the vehicle.

7. The collision detection apparatus according to claim 1, wherein:
a maximum detection distance of the radar is 30 m; and
it takes at least 0.65 second for the controller to perform the collision avoidance operation after receiving a result of detection by the radar.

8. The collision detection apparatus according to claim 1, wherein:
a maximum detection distance of the radar is 30 m; and
it takes at least 0.65 second for the controller to perform the collision damage reduction operation after receiving a result of detection by the radar.

9. The collision detection apparatus according to claim 1, wherein
the detection-direction center axis of the radar is a horizontal center axis extending in a direction in which the radar detects the object by emitting electromagnetic waves.

10. The collision detection apparatus according to claim 1, wherein
electromagnetic waves emitted by the radar are millimeter waves.

11. A vehicle characterized by comprising:
the collision detection apparatus according to claim 1; and
a safety system that performs at least one of a collision avoidance operation and a collision damage reduction operation under the control of the controller.

12. The vehicle according to claim 11, wherein:
the collision avoidance operation is an operation for assisting braking operation that a driver of the vehicle performs to avoid collision between the vehicle and the object; and
the safety system incorporates a danger avoidance device that assists the braking operation.

13. The vehicle according to claim 11, wherein:
the collision damage reduction operation is an operation for further restricting an occupant of the vehicle; and
the safety system incorporates a collision damage reduction apparatus that further restricts the occupant.

14. A collision detection method for a vehicle incorporating a radar that detects an object, characterized by comprising:
arranging the radar such that a horizontal center axis extending in a direction in which the radar detects the object by emitting electromagnetic waves is tilted to right or left by 20° to 60° with respect to a straightforward running direction of the vehicle; and
determining whether there is a possibility of collision between the vehicle and the object based on a result of detection by the radar.

15. The collision detection method according to claim 14, further comprising:
performing at least one of a collision avoidance operation and a collision damage reduction operation based on a result of the determination as to the collision possibility.
